(19) United States
(12) Patent Application Publication
(10) Pub. No.: US 2020/0073208 A1
(43) Pub. Date: Mar. 5, 2020

(54) Illumination system and recording system for volumetric capturing

(71) Applicant: Fraunhofer-Gesellschaft zur Förderung der angewandten Forschung e.V., Munchen (DE)

(72) Inventors: Bernd DUCKSTEIN, Berlin (DE); Peter KAUFF, Berlin (DE); Oliver SCHREER, Berlin (DE); Danny TATZELT, Berlin (DE); Christian WEISSIG, Berlin (DE); Ingo FELDMANN, Berlin (DE)

(21) Appl. No.: 16/679,626

(22) Filed: Nov. 11, 2019

Related U.S. Application Data
(63) Continuation of application No. PCT/EP2018/063399, filed on May 22, 2018.

(30) Foreign Application Priority Data
May 22, 2017 (EP) 17172260.6

(51) Int. Cl. G03B 15/07

(52) U.S. Cl. CPC G03B 15/07; G03B 2215/0592; G03B 2215/0596; G03B 2215/0582

(57) ABSTRACT

An illumination system for illuminating a scene location emits light from a light surface in order to form a keying background for recording the scene location.

### CROSS-REFERENCES TO RELATED APPLICATIONS

This application is a continuation of copending International Application No. PCT/EP2018/063399, filed May 22, 2018, which is incorporated herein by reference in its entirety, and additionally claims priority from European Application No. EP 17 172 260.6, filed May 22, 2017, which is incorporated herein by reference in its entirety.

### BACKGROUND OF THE INVENTION

The present application concerns an illumination system and a recording system for volumetric capturing or spatial detection of objects.

The recording of scenes by camera systems, particularly for keying recordings to separate objects from backgrounds, places certain demands on the illumination of the scene to be recorded. In general, spotlights that illuminate the scene selectively or diffusely are used for illumination. The spotlights may additionally be fitted with filters, such as color filters, to achieve certain illumination effects. The present application provides a system for illuminating and recording scenes which, compared to the illumination devices previously used, offers improved illumination of the objects in the scene to be recorded.

The core of the invention is that the illumination system emits light from a light surface to form a keying background for recording the scene.

### SUMMARY

An embodiment may have an illumination system for illuminating a scene location, wherein the illumination system is configured to emit light from a light surface in order to form a keying background for recording the scene location.

According to another embodiment, a recording system for recording a scene location may have: an inventive illumination system for illuminating the scene location, wherein the illumination system is configured to emit light from a light surface in order to form a keying background for recording the scene location; and at least one camera for recording the scene location with the keying background.

Another embodiment may have a method for recording a scene by means of an inventive recording system.

In an embodiment of the present invention, an illumination system is provided to illuminate a scene location, wherein the illumination system emits light from a light surface to form a keying background for recording the scene location.

In a second embodiment, the light surface surrounds the scene location.

In a third embodiment, the light surface surrounds the scene location on all sides.

In a fourth embodiment, the illumination system comprises a transmission surface diffuser and a backlight for illuminating a rear side of the transmission surface diffuser, wherein the light surface is formed by a front side of the transmission surface diffuser opposite the rear side.

In a fifth embodiment, the illumination system comprises one or more openings in the light surface through which a respective camera each may record the scene location.

In a sixth embodiment, the illumination system comprises several camera openings through which a respective camera each may record the scene location.

In a seventh embodiment, the camera openings are distributed around the scene location.

In an eighth embodiment, the camera openings are arranged around the scene location at the same angular distance from each other.

In a ninth embodiment, the backlight of the illumination system comprises controllable illuminants whose luminous intensity and/or luminous color may be controlled to form a time-variable keying background.

In a tenth embodiment, the illuminants include LEDs, LASER or thermal illuminants.

In an eleventh embodiment, the keying background may be varied temporally and locally.

In a twelfth embodiment, the illumination system includes a reflector that reflects light in the direction of the scene location.

In a thirteenth embodiment, the illumination system comprises a controller that performs synchronization between one or more cameras recording the scene location and a modulation of the emitted light.

In a fourteenth embodiment, the controller is set up to modulate the emitted light in such a way that the emission of the light is limited to an integration time of the cameras.

In a fifteenth embodiment, a controller is arranged to control the illumination system such that the keying background for each camera position from which recording of the scene location is provided comprises a portion surrounding a silhouette of a projection of an object in the scene location from the respective camera position onto the light surface, the portion differing in color and/or brightness from its surroundings of the portion.

In a sixteenth embodiment, the default color of the keying background beyond the portion is white for each camera position.

In a seventeenth embodiment, the light surface is essentially cylindrical.

According to an eighteenth embodiment, a recording system for recording a scene location is described, comprising an illumination system according to any one of the embodiment 1 to 16 for illuminating the scene location, wherein the illumination system emits light from a light surface to form a keying background for recording the scene location, and wherein the recording system includes at least one camera for recording the scene location with the keying background.

In a nineteenth embodiment, the camera comprises at least one set of cameras that form a multifocal basic system.

In a twentieth embodiment, the recording system includes a large number of cameras distributed around the scene location to record the scene type from various directions through openings in the light surface.

In a twenty-first embodiment, a recording system includes an image processor for performing, in a recording material obtained by the at least one camera, a discrimination between first image areas corresponding to the keying background and second image areas not corresponding to the keying background.

In a twenty-second embodiment, the illumination system is configured to emit white light, and the image processor is configured to use white as the key color for discrimination.

In a twenty-third embodiment, at least one camera includes an active depth sensor.

In a twenty-fourth embodiment, the recording system includes microphones or loudspeakers.

In a twenty-fifth execution embodiment, the recording system further includes an object identifier for a run time localization of an object in the scene location based on a recording material obtained by the at least one camera, wherein the illumination system comprises a controller which controls the illumination system such that the keying background for each camera comprises a portion surrounding a silhouette of a projection of the object from a camera position of the camera in the scene location onto the light surface, the portion differing in color and/or brightness from its surroundings of the portion.

According to a twenty-sixth embodiment, a method for recording a scene by means of a recording system is specified, wherein the recording system corresponds to one of the embodiments 18 to 25.

### BRIEF DESCRIPTION OF THE DRAWINGS

Embodiments of the present invention will be detailed subsequently referring to the appended drawings, in which:

FIG. 1 shows a schematic representation of an illumination system according to an embodiment;

FIG. 2 shows a schematic representation of a recording system according to an embodiment; and

FIG. 3 shows a flowchart of a method for recording a scene according to an embodiment.

### DETAILED DESCRIPTION OF THE INVENTION

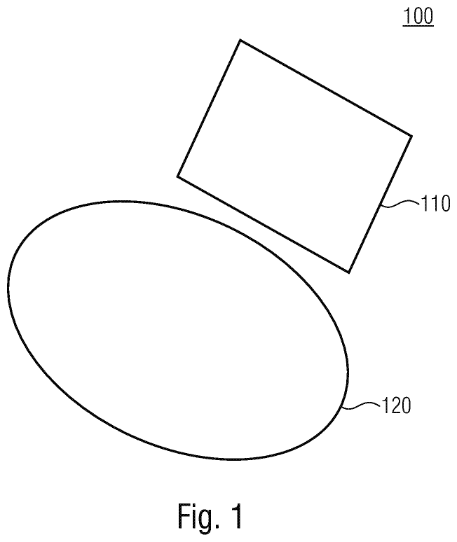

FIG. 1 schematically shows an illumination system 100 for illuminating a scene location. The illumination system 100 includes a light surface 110 and the scene location 120. FIG. 1 shows only an example of a possible embodiment, in this case, e.g., the scene location 120 is shown in a round shape, it is obviously possible that the scene location may be oval, may comprise the shape of a polygon, or may even comprise an entirely irregular shape. In addition, the light surface 110 is shown as a square and planar light surface that may illuminate the scene location from one side. This is also only an embodiment of the light surface 110, it is obviously also possible that the light surface 110 is not square or planar, but that it may comprise a different shape. For example, the light surface 110 may be round, semicircular, rectangular or polygonal, or it may also be freely shaped.

It is also not absolutely necessary for the light surface 110 to be planar. For example, the light surface may comprise a curvature. For example, if the scene location 120 is round or oval, the light surface 110 may be curved away from the scene location 120 so that it follows the boundary of the scene location. The light surface 110 may also be curved towards the scene location 120 so that the emitted light may be emitted more diffusely.

For example, if the scene location 120 is round in embodiments, it is possible that the light surface 110 comprises the shape of a cylinder segment and thus partially surrounds the scene location 120. In addition, it is also possible for the light surface 110 to be configured as a cylinder so that the light surface 110 surrounds the scene location 120, for example.

In embodiments, it is also possible that the light surface 110 surrounds the scene location 120 on all sides, for this purpose the light surface 120 may also comprise a kind of “roof surface” and a “floor surface” or be configured as such, so that the scene location 120 may then be additionally illuminated from above and below. Of course it is also possible that only one of the “roof surface” and the “floor surface” is configured as part of the light surface 110, in the case of the floor surface, it would be possible that static requirements would not allow it to be configured translucent because some transparent materials do not have the stability needed for a floor surface.

In some embodiments, the light surface 110 may be configured as a transmission surface diffuser that illuminates the scene location 120, e.g., by diffuse refraction with diffusely scattered light. The transmission surface diffuser may include backlighting. The backlighting is then arranged, e.g., on the rear side of the transmission surface diffuser, so that light from the backlighting hits the rear side of the transmission surface diffuser and emerges again on its front side, which faces in the direction of the scene location 120, and illuminates the scene location 120.

In an embodiment, the light surface 110 may be mechanically constructed as follows: If the light surface 110 is cylindrical, the light surface 110 includes a cylindrical arrangement of a) an inner shell that may serve as a diffuser and may comprise, e.g., openings for lenses, b) an installation plane that may include a support system with fixtures for installations such as illuminants, camera systems, illumination system, microphones, loudspeakers and the like, and c) an outer shell that may serve as a reflector.

An analogous structure naturally also applies to non-cylindrical light surfaces. For example, if the light surface is flat, then it would be more appropriate to speak of an inner level, an installation level and an outer level, but conceptually the structure is the same.

As mentioned above, such an embodiment may include an illuminated floor and/or an illuminated ceiling, and may have a concealed entrance so that the scene location may be entered through the light surface 110.

Through an arrangement in which inner and outer shells are spaced apart with the with the installation plane between them, the heat generated, e.g., by the lamps may cause a chimney effect that may lead to ventilation within the light surface. A chimney effect may also occur analogously at the scene location 120, i.e. within the volume formed by the light surface 110, e.g. the cylinder. In alternative embodiments, the light surface may be provided with an active ventilation element, such as a fan, providing ventilation. In an alternative embodiment, such an active ventilation element together with the chimney effect may also provide ventilation.

In embodiments, the illumination system 100 may be provided with a reflector that reflects light in the direction of the scene location 120. For example, viewed from scene location 120, this reflector may be located behind light surface 110, which, in the case of light sources emitting in all directions, reflects the light back towards the scene location, wherein this light would otherwise be lost for illuminating the scene location. For example, such a reflector may be formed by the aforementioned outer shell or plane.

In embodiments, since the illumination system 100 may be set up to allow camera recordings of the scene location, the light surface may comprise one or more openings through which one camera each may record the scene location 120.

In embodiments, such camera openings may be distributed around the scene location, on the one hand, these openings may be arranged regularly, e.g. at the same angular distance from each other, however, the camera openings may also be arranged irregularly with respect to angular position or height.

The aforementioned illuminating of the illumination system, e.g. for backlighting the inner shell, may have different types of illuminants. Thus, in embodiments, it is possible that the light sources may include LEDs, thermal light sources such as light bulbs or lasers. In embodiments, regardless of the nature of the illuminant, it is possible to control the illuminant separately, so that the luminous intensity and/or luminous color of the illuminant may be controlled in order to make it possible to form a temporally variable background.

In embodiments, this means that the light surface 110 may enable dynamic or non-homogeneous illumination of the scene location, so that different illumination effects may emanate from different locations of the light surface and/or from the light surface at different times. These illuminating effects may differ in illumination intensity and/or color. For example, if there is a moving object in scene location 120 that is to be recorded by a camera, it possible that the area of the light surface behind the moving object, as seen by the camera, is controlled with a more intensive illuminance, or that this area then has a different lighting color. In embodiments, since the object may move, it is then possible that this special lighting effect also changes spatially and temporally according to the movement of the object, i.e. quasi-following this moving object.

Such an illumination system, wherein the lighting intensity or color may temporally and locally change, may serve as a keying background. Keying is the term used to describe the process of separating picture elements from the background, usually on the basis of a key color, hence the term keying. A well-known example is the so-called bluescreen technique, which makes it possible to subsequently place objects or people in front of a different background.

In embodiments, the illumination system 100 may comprise with a control apparatus that modulates the emitted light, or to achieve synchronization between cameras and the emitted light. In certain embodiments, if certain light intensities or certain illumination colors are to be used for keying, the color and/or intensity of the emitted light may then be modulated and be brought in synchronization with the corresponding cameras. In embodiments, the modulation is carried out in such a way that the emission of the light, or light of a certain color or intensity, is limited for an integration time of the cameras. In embodiments, this means that the modulation of the light only takes place for a period of time corresponding to the integration time of a camera. This may be advantageous if, e.g., a blue light color is needed for keying, wherein such a light color is advantageous for the camera used, but not for people in the scene location. Since light of an unnatural light color may lead to unusual contrast effects for humans and such effects may then cause nausea in humans, it is more advantageous to light the scene location mainly with a natural light color and to use the color needed for keying only for fractions of a second in which the camera is “active”, i.e. during the integration time of a camera.

In further embodiments, the controller may be set up to control the illumination system 100 such that the keying background for each camera position from which the scene location is to be recorded comprises a portion that differs in color and/or brightness from the surrounding distances, wherein the portion of a silhouette corresponds to a projection of the recorded object in the scene location 120. This means that if, e.g., an actor is in the scene location and this actor is to be separated from the background, only a portion corresponding to the actors silhouette is selected to modulate this portion in color and/or brightness.

Although a prominent example of a keying technique, the so-called bluescreen technique, uses a blue background, the color of the keying background is not limited to blue. In other words, it may be useful, e.g. to minimize eye irritation, that only a small area of the scene location 120 is given a background in the keying color and the rest of the scene is lit/backlit with a standard color (default color). The default color may be white, but an opponent color to the keying color may also be used, e.g., if the keying color is green, the opponent color would be red. In embodiments, this means that the keying background comprises a default color, which may be white for any camera position, and undergoes modulation, wherein the modulation changes color and/or luminosity/brightness.

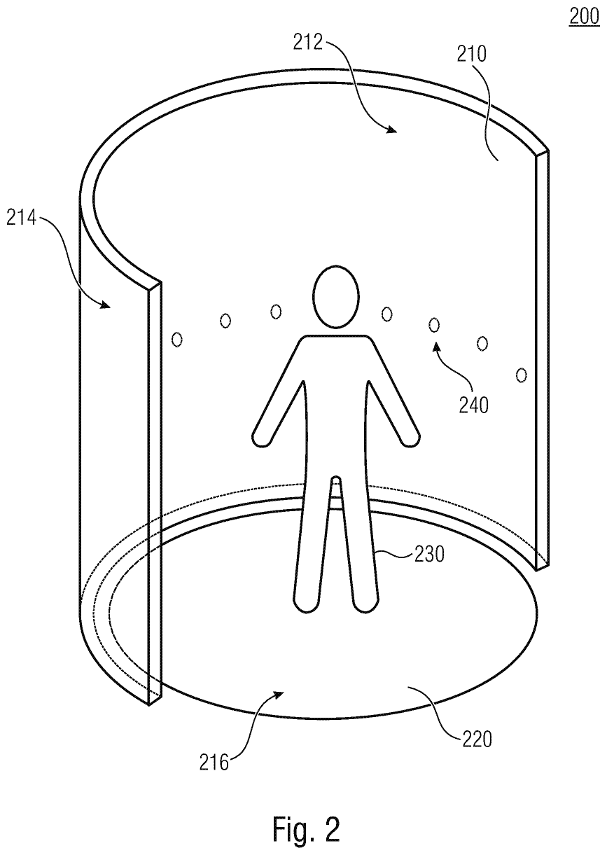

FIG. 2 shows the schematic structure of a recording system 200 including an illumination system 100. The recording system 200 includes a scene location 220 and a light surface 210. In this embodiment, as described above in relation to FIG. 1, the light surface is arranged around the scene location 220; however, the light surface does not have to be cylindrical as shown in the illustration. Here, the light surface could also be a planar surface, or surround the scene location as a polyhedral arrangement, e.g. having a regular polygon as the base structure. In FIG. 2, an object 230 is also shown in the scene location 220, in the present case the object 230 is symbolized by a human being. In addition, the light surface 210 comprises openings 240 through which camera recordings may be performed.

In FIG. 2, it is indicated that the light surface 210 cylindrically surrounds the scene location, and that the light surface 210 is three-dimensional in the sense that it comprises a volume, or an inner surface, facing the scene location, and comprises a further outer surface located on the side facing away from the scene location. Illuminants are arranged between the inner and outer walls of the light surface, the light sources may include lasers, incandescent lamps or LEDs.

In embodiments, not only the light surface 210 may emit light, but the floor 216 of the recording system may be equipped with illuminants so that the floor may also light the scene location. In addition, like the floor 216, a ceiling (not shown in FIG. 2) may also be provided with a light source to light the scene location 220. What has been mention in relation to the light surface applies in principle also to the floor 216 or the ceiling of the recording apparatus, namely that they are also provided with illuminants, wherein these illuminants may be controlled so that the illumination properties such as color or intensity are variable in time and place.

In the following, the mechanical structure of the light surface 210 will be described. In the present case, the light surface 210 is a cylindrical arrangement consisting of an inner shell, an installation plane and an outer shell 214. The inner shell 212 faces the scene location 220, is configured to serve as a diffuser and comprises openings for camera lenses. In embodiments, the outer shell 214 closes off the light surface to the outside and may be used as a reflector. This reflector reflects light that is emitted by the light sources and would not reach the scene location. Thus, the reflector helps to increase the efficiency of the illumination system. Between the inner shell 212 and the outer shell 214 there is an installation level which, on the one hand, is set up as a supporting system to provide fixtures for installations, and may also accommodate camera systems, the illumination system, microphones and loudspeakers.

Furthermore, as described above, the mechanical structure of the entire illumination system may include an illuminated floor 216 and an illuminated ceiling. The mechanical structure comprises a concealed entrance, e.g., so that actors may enter the recording system. Furthermore, in order to keep the light surface within specified temperature ranges, a chimney effect is used which serves to ventilate the interior of the light surface. This chimney effect takes place within the light surface/wall.

As previously mentioned, the wall serves as an illumination system, in some embodiments, this may also be the floor and/or the ceiling. The wall may be emitted from the inside or outside, using LEDs, lasers or projection apparatuses as the light source. In addition, the recording system comprises a camera system, the camera system may be synchronized with the light source. For example, this enables the operation of the light surface by means of pulse width modulation, PWM, so that the illumination may only be switched on during the integration time of the image sensors of the camera system. Thus the glare effect for actors and personnel may be reduced.

As previously mentioned, the illumination may be adjusted with a local and temporal resolution. For example, the local resolution may be given by the LED grid of the LED emitter or by a pixel grid of a rear projection system or front projection system. The possibility of controlling the light surface enables the color values and brightness to be adjusted dynamically in terms of time and location. By combining the illumination with neutral density filters as contact lenses, the glare effect may be even further reduced.

Thus, the existing illumination system may be used for object illumination and keying at the same time.

In a first variation, a so-called clipping may be used instead of keying. For this purpose, the object illumination is ideally kept in a neutral white. In the case that the light surface cylindrically surrounds the scene location, the brightness of the illumination system is referred to as rotunda and is set so that a recording leads to overexposure. This overexposure may be used to separate objects such as the object 230 from the background. This is a special case of the so-called luma keying.

In a second variation, a mixed and dynamic keying may be used. This is a combination of croma keying and luma keying. In this variation, the background is primarily white to ensure the best scene illumination. The background in front of certain objects may be partially adjusted in its brightness value and color value so that an optimal keying may be achieved. Different background colors and key values may be individually adjusted in terms of time and location, allowing a best possible adaptation to the key behavior of the objects. So-called clean plates may be used to locate backgrounds such as the lenses of the cameras. These clean plates also enable the static determination of key values. The evaluation of the recordings may be used for dynamic setting, or adjustment, of the key values.

With respect to the camera arrangement in the recording system 200, cameras may be arranged in multifocal basic systems, such as stereo, trifocal or quad focal. The multifocal basic systems may be attached at any height in the walls as well as in the ceiling and the floor. This allows the scene to be recorded from different perspectives. The multifocal basic systems may also be provided with active depth sensors to optimally adjust the camera parameters. The depth sensors may perform so-called structured-light measurements or time-of-flight measurements.

Individual cameras of the camera system may be attached as reference cameras or monitoring cameras in the walls, ceiling or floor. These then offer reference values to match with other cameras. If needed, the height adjustment of the cameras may be carried out automatically and adaptively. This allows a variable adjustment of the recording perspective. The cameras may also comprise different focal lengths to achieve different recording effects.

The cameras are synchronized with each other and with the illumination system in order to control an adjustment of light intensity and color value during the integration time of the cameras, as previously described, in order to enable an overall good keying, but, on the other hand, to reduce the glare effect.

Previously, it was described that the cameras could be arranged with the same angular distance to each other, for example. However, this is not absolutely necessary, the distribution of the cameras may also be non-periodic; any number of cameras that may be arranged arbitrarily in the cylinder of the light surface is possible. If needed, the cameras may dynamically adjust focus, opening and focal length during recording to achieve the best possible recording effects. The camera parameters, such as opening, focus and focal length, as well as the illumination parameters, such as intensity and color, may be determined both before the recording and adaptively during the recording. In the latter case, a content-related adjustment of all mentioned parameters may be carried out based on the scene to be recorded. For example, the sharpness may be dynamically adjusted to the actor being recorded. A content-based adjustment of the camera parameters may be performed simultaneously for all multifocal camera basic systems on a common database, which increases the robustness of the system. For example, the parameters may first be determined separately from the individual multifocal basic systems and then combined in a subsequent analysis step, resulting in a common parameter set that is then adapted and used for all cameras.

As previously mentioned, the light surface may also have microphones. These may be used for 360° microphone setup for spatial sound recording in the recording room. In addition, individual microphones may be available which enable an individual microphone setup for the actors (radio path). In addition, loudspeakers may be arranged in the light surface 210 to enable acoustical emission during a performance.

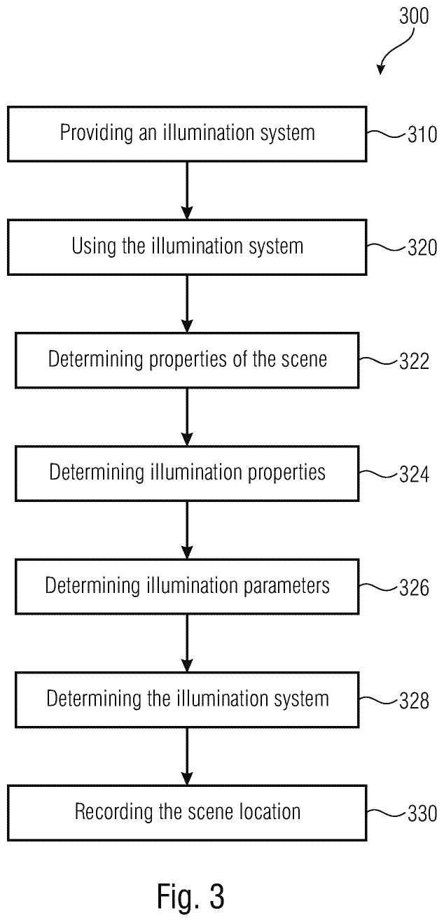

FIG. 3 shows a flow chart of a method for operating a recording system, as shown and described in FIG. 2, for example.

In a first step 310, an illumination system as described in connection with FIG. 1 or 2 is provided.

In step 320, this illumination system is used to emit light toward the scene location.

Step 320 may still include one or more “sub-steps”, but these may also be performed independently of step 320.

In step 322, properties of the scene may be determined, e.g. the position of certain objects such as people or items within the scene location. This may be done by using cameras or by querying a database in which the provided or determined position of people or items is stored, for example. For example, an object recognizer may be used to localize an object in the scene, wherein said object recognizer may recognize objects in a scene recorded by a camera and determine their position even at run time.

In step 324, it may be determined which properties the illumination system is to comprise. The illumination system properties may relate to the intensity and/or color of the illumination and to its spatial and/or temporal course. They may also refer to whether a keying background is to be provided.

In step 326, illumination parameters that may be used to control the illumination system are determined from the illumination system, e.g. by a computer provided for this purpose or by a control device such as a microcontroller. The illumination parameters may be determined based on the determined properties of the scene and/or properties of the illumination system.

For example, the illumination parameters determined may enable dynamic or non-homogeneous illumination of the scene location, so that different illumination effects may emanate from the light surface at different positions of the light surface and/or at different times. These illumination effects may differ in terms of illumination intensity and/or color, for example. For example, it is possible for a moving object in the scene location to be illuminated in such a way that the area of the light surface behind the moving object is provided with a different, e.g. more intense, intensity of illumination or a different illumination color. In embodiments, this special illumination effect may change according to the movement of the object. Thus, an illumination system controlled in this way may serve as a keying background. In embodiments, as mentioned above, the illumination system may comprise a control device that modulates the emitted light, or to achieve a synchronization between the cameras and the emitted light. In particular, it is possible that the scene location may be illuminated with a natural light color, and that the color needed for keying may only be used for fractions of a second in which the corresponding camera is “active”.

Furthermore, the illumination parameters may be used to dynamically adjust the focus, aperture and focal length of one or more cameras during recording in order to achieve optimal recording effects. The determination of the illumination parameters, and from this, e.g., the determination of the parameters for aperture, focus and focal length of the camera(s), as well as the intensity and color of the illumination, may be done both before the recording and may be adaptively adjusted during the recording. An adaptive adjustment of all mentioned parameters may be done based on the scene to be recorded. As mentioned above, a content-based adjustment of the camera parameters for the, in embodiments multifocal, camera systems may be performed simultaneously based on a common data, which increases the robustness of the system. With multifocal camera systems, in addition to the adaptation of the camera parameters mentioned above, a switch to a camera that is most suitable for the particular focus parameter may also be carried out.

In step 328, the illumination system settings are adjusted based on the illumination parameters determined. If needed, the camera settings are also adjusted according to the determined illumination parameters.

In step 330, a recording of the scene location is performed using the cameras and the accordingly adjusted illumination system.

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described within the context of or as a method step also represent a description of a corresponding block or detail or feature of a corresponding device. Some or all of the method steps may be performed while using a hardware device, such as a microprocessor, a programmable computer or an electronic circuit. In some embodiments, some or several of the most important method steps may be performed by such a device.

Depending on specific implementation requirements, embodiments of the invention may be implemented in hardware or in software. Implementation may be effected while using a digital storage medium, for example a floppy disc, a DVD, a Blu-ray disc, a CD, a ROM, a PROM, an EPROM, an EEPROM or a FLASH memory, a hard disc or any other magnetic or optical memory which has electronically readable control signals stored thereon which may cooperate, or cooperate, with a programmable computer system such that the respective method is performed. This is why the digital storage medium may be computer-readable. Some embodiments in accordance with the invention thus comprise a data carrier which comprises electronically readable control signals that are capable of cooperating with a programmable computer system such that any of the methods described herein is performed.

Generally, embodiments of the present invention may be implemented as a computer program product having a program code, the program code being effective to perform any of the methods when the computer program product runs on a computer. The program code may also be stored on a machine-readable carrier, for example. Other embodiments include the computer program for performing any of the methods described herein, said computer program being stored on a machine-readable carrier. In other words, an embodiment of the inventive method thus is a computer program which has a program code for performing any of the methods described herein, when the computer program runs on a computer.

A further embodiment of the inventive methods thus is a data carrier (or a digital storage medium or a computer-readable medium) on which the computer program for performing any of the methods described herein is recorded. The data carrier, the digital storage medium, or the recorded medium are typically tangible, or non-volatile. A further embodiment of the inventive method thus is a data stream or a sequence of signals representing the computer program for performing any of the methods described herein. The data stream or the sequence of signals may be configured, for example, to be transferred via a data communication link, for example via the internet.

A further embodiment includes a processing means, for example a computer or a programmable logic device, configured or adapted to perform any of the methods described herein. A further embodiment includes a computer on which the computer program for performing any of the methods described herein is installed. A further embodiment in accordance with the invention includes a device or a system configured to transmit a computer program for performing at least one of the methods described herein to a receiver. The transmission may be electronic or optical, for example. The receiver may be a computer, a mobile device, a memory device or a similar device, for example. The device or the system may include a file server for transmitting the computer program to the receiver, for example. In some embodiments, a programmable logic device (for example a field-programmable gate array, an FPGA) may be used for performing some or all of the functionalities of the methods described herein. In some embodiments, a field-programmable gate array may cooperate with a microprocessor to perform any of the methods described herein. Generally, the methods are performed, in some embodiments, by any hardware device. Said hardware device may be any universally applicable hardware such as a computer processor (CPU), or may be hardware specific to the method, such as an ASIC.

For example, the devices described herein may be implemented using a hardware device, or using a computer, or using a combination of a hardware device and a computer.

The devices described herein, or any components of the apparatuses described herein, may at least be partially implement in hardware and/or software (computer program). For example, the methods described herein may be implemented using a hardware device, or using a computer, or using a combination of a hardware device and a computer. The methods described herein, or any components of the methods described herein, may at least be partially performed by hardware and/or software.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. An illumination system for illuminating a scene location, wherein the illumination system is configured to emit light from a light surface in order to form a keying background for recording the scene location.

2. The illumination system according to claim 1, wherein the illumination system is configured such that the light surface surrounds the scene location.

3. The illumination system according to claim 1, wherein the illumination system is configured such that the light surface surrounds the scene location on all sides.

4. The illumination system according to claim 1, wherein the illumination system comprises a transmission surface diffuser and a backlight for illuminating a rear side of the transmission surface diffuser, wherein the light surface is formed by a front side of the transmission surface diffuser opposite the rear side.

5. The illumination system according to claim 1, wherein the illumination system comprises one or more camera openings in the light surface through which one camera each may record the scene location.

6. The illumination system according to claim 1, wherein the illumination system comprises several camera openings through which one camera each may record the scene location.

7. The illumination system according to claim 6, wherein the camera openings are distributed around the scene location.

8. The illumination system according to claim 6, wherein the camera openings are arranged around the scene location at the same angular distance from each other.

9. The illumination system according to claim 4, wherein the backlight of the illumination system comprises controllable illuminants whose luminous intensity and/or luminous color may be controlled to form a time-variable keying background.

10. The illumination system according to claim 9, wherein the illuminants comprise LEDs, LASER or thermal illuminants.

11. The illumination system according to claim 1, wherein the keying background is temporally and locally variable.

12. The illumination system according to claim 1, wherein the illumination system comprises a reflector that reflects light in the direction of the scene location.

13. The illumination system according to claim 1, further comprising a controller that performs a synchronization between one or several cameras recording the scene location and a modulation of the emitted light.

14. The illumination system according to claim 13, wherein the controller is configured to modulate the emitted light in such a way that the emission of the light is limited to an integration time of the one or several cameras.

15. The illumination system according to claim 1, further comprising a controller configured to control the illumination system such that the keying background for each camera position from which recording of the scene location is intended comprises a portion surrounding a silhouette of a projection of an object in the scene location from the respective camera position onto the light surface, the portion differing in color and/or brightness from its surroundings of the portion.

16. The illumination system according to claim 15, wherein the default color of the keying background beyond the portion for each camera position is white.

17. The illumination system according to claim 1, wherein the light surface is essentially cylindrical.

18. A recording system for recording a scene location, comprising:
an illumination system according to claim 1 for illuminating the scene location, wherein the illumination system is configured to emit light from a light surface in order to form a keying background for recording the scene location; and
at least one camera for recording the scene location with the keying background.

19. The recording system according to claim 18, wherein the at least one camera comprises at least one set of cameras that form a multifocal basic system.

20. The recording system according to claim 18, wherein the recording system comprises a multitude of cameras distributed around the scene location to record the scene location from various directions through openings in the light surface.

21. The recording system according to claim 18, further comprising an image processor for performing, in a recording material acquired by the at least one camera, a discrimination between first image areas corresponding to the keying background and second image areas not corresponding to the keying background.

22. The recording system according to claim 21, wherein the illumination system is configured to emit white light, and the image processor is configured to use white as the key color for discrimination.

23. The recording system according to claim 18, wherein the at least one camera comprises an active depth sensor.

24. The recording system according to claim 18, wherein the recording system comprises microphones or loudspeakers.

25. The recording system according to claim 18, comprising:
an object identifier for a run time localization of an object in the scene location based on a recording material acquired by the at least one camera,
wherein the illumination system comprises a controller configured to control the illumination system such that the keying background for each camera comprises a portion surrounding a silhouette of a projection of the object from a camera position of the camera in the scene location onto the light surface, the portion differing in color and/or brightness from its surroundings of the portion.

26. A method for recording a scene by means of a recording system according to claim 18.
